(19) United States
(12) Patent Application Publication
(10) Pub. No.: US 2006/0271337 A1
(43) Pub. Date: Nov. 30, 2006

(54) Method and apparatus to detect a missing nozzle

(76) Inventor: Jong-un Jeong, Suwon-si (KR)

Correspondence Address: STANZIONE & KIM, LLP, 919 18TH STREET, N.W., SUITE 440, WASHINGTON, DC, 20006, US

(21) Appl. No.: 11/434,881

(22) Filed: May 17, 2006

(30) Foreign Application Priority Data
May 24, 2005 (KR) 2005-43768

(51) Int. Cl. G06F 19/00

(52) U.S. Cl. 702/183

(57) ABSTRACT

A method and apparatus to detect a missing nozzle. The missing nozzle detection apparatus includes a nozzle classifying unit which groups the nozzles by classifying the nozzles according to a predetermined criterion, a print unit which prints each of the classified groups of nozzles, and a nozzle inspection unit which detects the missing nozzle by scanning the result printed by the print unit, wherein the nozzle classifying unit classifies the nozzles based on a scanning resolution of the nozzle inspection unit. A resolving power can be improved and the missing nozzle can be exactly detected using an existing scan sensor instead of a high performance scan sensor, and manufacturing costs can be reduced and printing quality can be improved.

### CROSS-REFERENCE TO RELATED APPLICATIONS

This application claims the benefit of Korean Patent Application No. 10-2005-0043768, filed on May 24, 2005, in the Korean Intellectual Property Office, the disclosure of which is incorporated herein in its entirety and by reference.

### BACKGROUND OF THE INVENTION

1. Field of the Invention

The present general inventive concept relates to an image forming apparatus, and more particularly, to a method and apparatus to detect a missing nozzle by printing and scanning nozzles that are grouped according to a predetermined criterion.

2. Description of the Related Art

A missing nozzle can be caused by ink clogging, a malfunctioning heater or actuator, or an error in a power supply circuit. The missing nozzle degrades print quality since the missing nozzle leaves a white space in a printed image.

Thus, a method of detecting the missing nozzle and printing with remaining working nozzles without using the missing nozzle is required in a printer driver.

A conventional missing nozzle detection apparatus detects the missing nozzle by printing a test pattern by ejecting droplets onto a printing medium through nozzles and scanning the test pattern with a scanning sensor.

According to the conventional missing nozzle detection apparatus, when a print resolution is higher than a resolution of the scanning sensor, or when light is infiltrated from an outside of an image forming apparatus according to a characteristic of light sources of the scanning sensor, a resolving power decreases, and therefore, it is hard to correctly detect the missing nozzle. In addition, to precisely detect the missing nozzle in a high resolution image forming apparatus, scanning takes too much time, and also an expensive high performance scanning sensor must be used, thereby increasing a manufacturing cost.

### SUMMARY OF THE INVENTION

The present general inventive concept provides a method and apparatus to detect a missing nozzle by printing and scanning nozzles that are grouped according to a predetermined criterion.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to detect a missing nozzle among a plurality of nozzles, the apparatus including a nozzle classifying unit which groups the nozzles by classifying the nozzles according to a predetermined criterion, a print unit which prints each of the classified groups of nozzles, and a nozzle inspection unit which detects the missing nozzle by scanning a result printed by the print unit, wherein the nozzle classifying unit classifies the nozzles based on a scanning resolution of the nozzle inspection unit.

The nozzle classifying unit may group the nozzles by classifying the nozzles such that all the nozzles can be inspected based on the scanning resolution of the nozzle inspection unit.

The nozzle classifying unit may include a pitch calculator which calculates a dot pitch based on the scanning resolution of the nozzle inspection unit, and a nozzle grouping unit which groups the nozzles by classifying the nozzles according to the calculated dot pitch.

The print unit may sequentially print each of the classified groups of nozzles on a printing medium.

The print unit may move the printing medium by a predetermined distance after printing using each of the classified groups of nozzles.

The foregoing and/or other aspects and utilities of the present general inventive concept may also be achieved by providing an apparatus to detect a missing nozzle among a plurality of nozzles, including a nozzle classifying unit which groups the nozzles by classifying the nozzles such that each group includes nozzles in a same row of a nozzle arrangement, a print unit which prints each of the classified groups of nozzles, and a nozzle inspection unit which detects the missing nozzle by scanning the result printed by the print unit.

The nozzle classifying unit may group nozzles by classifying the nozzles such that each group including the nozzles in the rows of a nozzle arrangement whose identification numbers have the same remainder when divided by a predetermined natural number.

The nozzle classifying unit may vary the natural number according to the scanning resolution of the nozzle inspection unit.

The print unit may sequentially print using each of the classified groups of nozzles on a printing medium.

The print unit may move the printing medium after printing each of the classified groups of nozzles.

The foregoing and/or other aspects and utilities of the present general inventive concept may also be achieved by providing a method of detecting a missing nozzle among a plurality of nozzles, including grouping the nozzles by classifying the nozzles according to a predetermined criterion, printing each of the classified groups of nozzles, detecting the missing nozzle by scanning a result obtained by printing in the printing, wherein in the grouping of the nozzles, the nozzles are classified based on a scanning resolution used in the detecting.

In the grouping of the nozzles, the nozzles may be grouped by classifying the nozzles such that all the nozzles can be inspected based on the scanning resolution used in the detecting of the missing nozzle.

The grouping of the nozzles may include calculating a dot pitch based on the scanning resolution used in the detecting of the missing nozzle, and grouping the nozzles by classifying the nozzles according to the calculated dot pitch.

In the printing of each of the classified groups of nozzles, each of the classified groups of nozzles may be sequentially printed on a printing medium.

In the printing of each of the classified groups of nozzles, the printing medium may be moved by a predetermined distance after printing each of the classified groups of nozzles.

The foregoing and/or other aspects and utilities of the present general inventive concept may be achieved by providing a computer readable medium having recorded thereon a computer readable program to perform a method of detecting a missing nozzle among a plurality of nozzles, the computer readable medium including a first code to group the nozzles by classifying the nozzles according to a predetermined criterion, a second code to print each of the classified groups of nozzles, a third code to detect the missing nozzle by scanning the result obtained by printing in the printing, wherein in the first code, the nozzles are classified based on a scanning resolution used in the third code to detect.

The foregoing and/or other aspects and utilities of the present general inventive concept may also be achieved by providing a method of detecting a missing nozzle among a plurality of nozzles, including grouping the nozzles by classifying the nozzles, each group including nozzles in the same row of a nozzle arrangement, printing each of the classified groups of nozzles, and detecting the missing nozzle by scanning a result printed in the printing.

In the grouping of the nozzles, the nozzles are grouped in the rows of a nozzle arrangement whose identification numbers have the same remainder when divided by a predetermined natural number may be grouped.

In the grouping of the nozzles, the natural number may be varied according to the scanning resolution used in the detecting.

In the printing of each of the classified groups of nozzles, each of the classified groups of nozzles may be sequentially printed on a printing medium.

In the printing of each of the classified groups of nozzles, the printing medium may be moved by a predetermined distance after printing each of the classified groups of nozzles.

The foregoing and/or other aspects and utilities of the present general inventive concept may also be achieved by providing a computer readable medium to perform a method of detecting a missing nozzle among a plurality of nozzles in an image forming apparatus, including a first executable code to group the nozzles by classifying the nozzles, each group including nozzles in the row of a nozzle arrangement, a second executable code to print each of the classified groups of nozzles, and a third executable code to detect the missing nozzle by scanning a result printed in the printing.

The foregoing and/or other aspects and utilities of the present general inventive concept may also be achieved by providing an image forming apparatus including a printing unit having nozzles and having a first resolution, a scanning unit having a second resolution different from the first resolution, and a unit to group the nozzles into a plurality of groups of nozzles so that each group of nozzles has a third resolution different from the first resolution.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a missing nozzle detection apparatus according to an embodiment of the present general inventive concept;

FIG. 2 is a flowchart illustrating a missing nozzle detection method according to an embodiment of the present general inventive concept;

FIGS. 3-8 are diagrams illustrating groups of nozzles of the missing nozzle detection apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

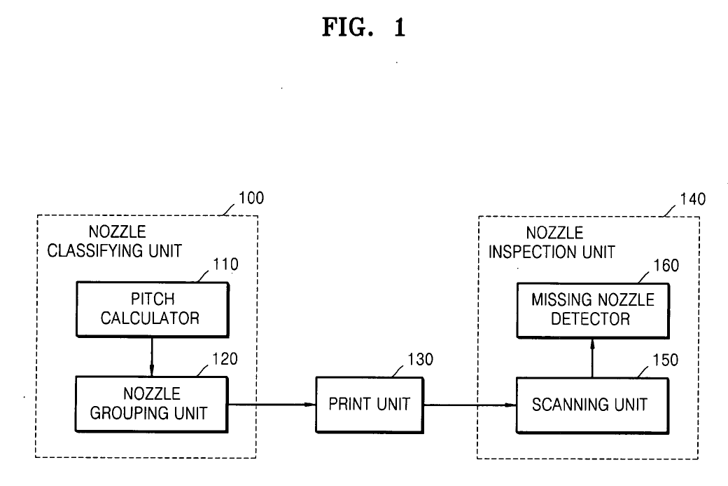

FIG. 1 is a block diagram illustrating a missing nozzle detection apparatus according to an embodiment of the present general inventive concept. Referring to FIG. 1, the missing nozzle detection apparatus includes a nozzle classifying unit 100, a print unit 130, and a nozzle inspection unit 140.

The nozzle classifying unit 100 groups nozzles by classifying the nozzles according to a predetermined criterion. The nozzle classifying criterion may be a scanning resolution of a scanning unit 150, a dot pitch, or rows in which the nozzles are arranged.

The nozzle classifying unit 100 includes a pitch calculator 110 and a nozzle grouping unit 120.

The pitch calculator 110 calculates the dot pitch based on the scanning resolution of the scanning unit 150. The dot pitch calculated by the pitch calculator 110 is a dot interval which allows dots ejected from the nozzles to be correctly scanned based on the scanning resolution of the scanning unit 150. The pitch calculator 110 may have a memory (not illustrated) to store the resolution of the scanning unit 150 and/or the dot pitch based on the scanning resolution of the scanning unit 150.

The nozzle grouping unit 120 groups the nozzles by classifying the nozzles according to the dot pitch calculated by the pitch calculator 110.

The print unit 130 sequentially prints on a printing medium using each of the classified groups of nozzles classified by the nozzle classifying unit 100. Every time each of the classified groups of nozzles classified by the nozzle classifying unit 100 finishes printing, the print unit 130 moves the printing medium by a predetermined distance and starts printing using a subsequent classified group of nozzles. The sequential printing of each of the classified groups of nozzles enables an exact scanning of the scanning unit 150.

The nozzle inspection unit 140 detects a missing nozzle by scanning a result printed by the print unit 130.

The nozzle inspection unit 140 includes the scanning unit 150 and a missing nozzle detector 160.

The scanning unit 150 scans the result printed by the print unit 130. The scanning unit 150 includes a scanning sensor, which radiates light onto the printing medium and scans the result printed by the print unit 130 using the light reflected from the printing medium.

The missing nozzle detector 160 detects the missing nozzle from the result printed by the print unit 130. The missing nozzle detector 160 detects the missing nozzle by comparing the intensity of the light received by the scanning sensor of the scanning unit 150 with a threshold.

In another embodiment of the present general inventive concept, the nozzle classifying unit 100 may group the nozzles by classifying the nozzles based on the scanning resolution of the scanning unit 150. The nozzle classifying unit 100 may group the nozzles such that all the nozzles can be inspected based on the scanning resolution of the scanning unit 150.

In another embodiment of the present general inventive concept, the nozzle classifying unit 100 groups the nozzles by classifying the nozzles into groups, each group including nozzles in a same row of a nozzle arrangement. The nozzle classifying unit 100 may also group the nozzles into groups, each group including nozzles in rows of a nozzle arrangement whose identification numbers have the same remainder when divided by a predetermined natural number. For example, the nozzles may be grouped into odd rows and even rows.

The nozzle classifying unit 100 adjusts the natural number corresponding to the divisor based on the scanning resolution of the scanning unit 150.

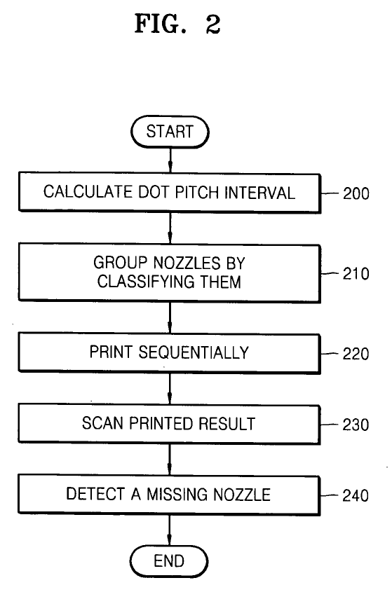

FIG. 2 is a flowchart illustrating a method of detecting a missing nozzle according to an embodiment of the present general inventive concept.

In operation 200, an interval of a dot pitch is calculated based on a scanning resolution of a scanning sensor. The dot pitch calculated in operation 200 is a dot interval which allows dots ejected from nozzles to be exactly scanned based on the scanning resolution of the scanning sensor.

In operation 210, the nozzles are grouped by classifying the nozzles according to the dot pitch calculated in operation 200 and/or the scanning resolution.

In operation 220, each of the classified groups of nozzles classified in operation 210 is sequentially printed on a printing medium. Every time each of the classified groups of nozzles finishes printing in operation 220, the printing medium is moved by a predetermined distance, and printing of a subsequent classified group of nozzles starts. The sequential printing of each of the classified groups of nozzles enables an exact scanning in operation 230.

In operation 230, a result printed in operation 220 is scanned by the scanning sensor. The scanning sensor radiates light onto the printing medium and scans the result printed in operation 220 using a light reflected from the printing medium.

In operation 240, a missing nozzle is detected by analyzing the result scanned in operation 230.

The missing nozzle is detected in operation 240 by comparing an intensity of the reflected light scanned by the scanning sensor with a threshold intensity.

In another embodiment, in operation 200, the nozzles may be grouped by classifying them into groups, each group including nozzles in a same row of a nozzle arrangement. In another embodiment, nozzles are grouped in groups including the nozzles in rows of a nozzle arrangement whose identification numbers have a same remainder when divided by a predetermined natural number. For example, the nozzles can be grouped into odd rows and even rows.

In operation 210, the natural number corresponding to the divisor in operation 200 is varied based on the scanning resolution of the scanning sensor.

In another embodiment, in operation 200, the nozzles are grouped based on the scanning resolution of the scanning sensor. The nozzles may be grouped in operation 200 such that all the nozzles can be inspected based on the scanning resolution of the scanning sensor.

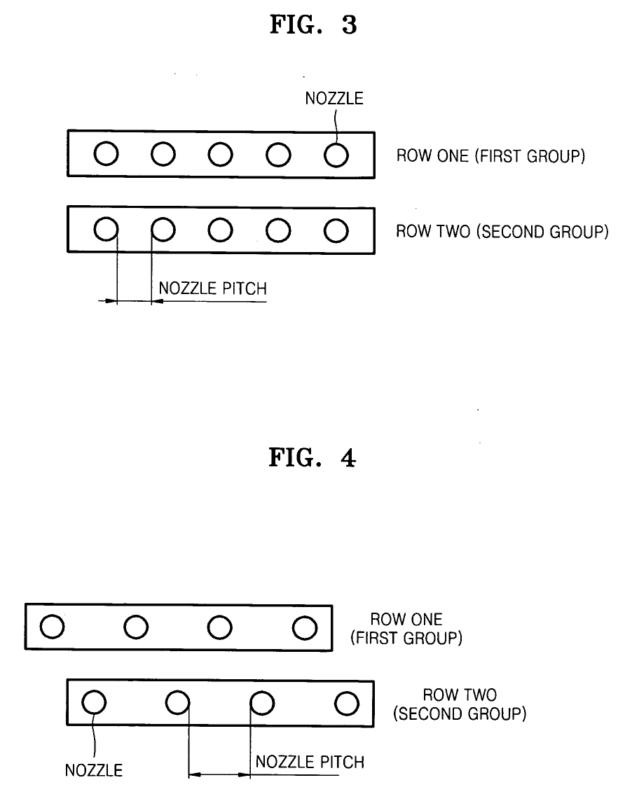

FIG. 3 is a diagram illustrating a plurality of nozzles according to an embodiment of the present general inventive concept. Referring to FIG. 3, the nozzles are arranged into a first row and a second row. The nozzles of the first and second rows are horizontally arranged such that the nozzles are vertically aligned. The nozzles are then grouped by the row of the nozzles into a first group and a second group.

FIG. 4 is a diagram illustrating a plurality of nozzles according to an embodiment of the present general inventive concept. Referring to FIG. 4, the nozzles are arranged so that the nozzles alternate horizontally between the first row and the second row such that the nozzles from the fist row are offset from the second row of the nozzles. The nozzles are grouped into groups based on the row of the nozzles, a first group and a second group corresponding to the first row and the second row, respectively.

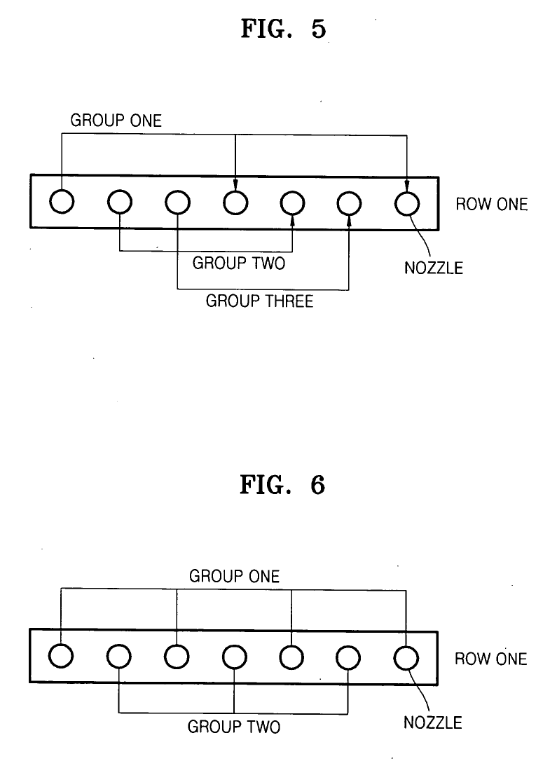

FIGS. 5, 6, and 7 are diagrams illustrating other exemplary groupings of the nozzles illustrated in FIG. 3 according to the present general inventive concept. The nozzle grouping unit 120 may group the nozzles by classifying the nozzles according to the dot pitch calculated by the pitch calculator 110. In another embodiment, the nozzle grouping unit 120 may group the nozzles in groups by rows of the nozzle arrangement whose identification numbers have the same remainder when divided by the predetermined natural number.

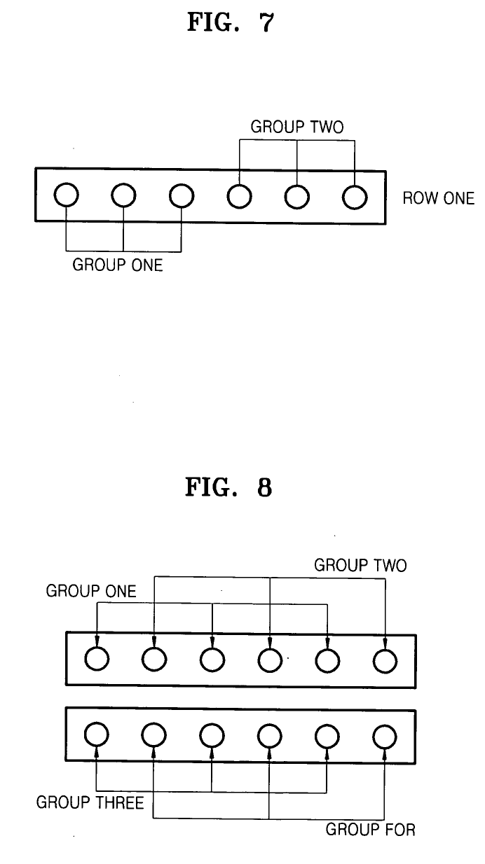

Referring to FIG. 5, the nozzles are grouped into three groups, a first group, a second group, and a third group. The first group includes the first nozzle and every third nozzle after the first (first nozzle, fourth nozzle, seventh nozzle, etc.). The second group includes the second nozzle and every third nozzle after the second (second nozzle, fifth nozzle, etc.). The third group includes the third nozzle and every third nozzle after the third nozzle (third nozzle, sixth nozzle, etc.). Referring to FIG. 6, the nozzles are grouped into a first group and a second group. The nozzles for each group alternate so that the first group has the odd numbered nozzles (first nozzle, third nozzle, etc) and the second group has the even numbered nozzles (second nozzle, fourth nozzle, etc.). Referring to FIG. 7, the nozzles are grouped into a first group and a second group. The first group contains a consecutive number of nozzles (first nozzle, second nozzle, and third nozzle) and the second group contains another consecutive number of nozzles (fourth nozzle, fifth nozzle, and sixth nozzle).

FIG. 8 is a diagram illustrating another exemplary grouping of the nozzles illustrated in FIG. 4. The nozzles are arranged into a first group, a second group, a third group, and a fourth group. The first and second groups include alternating nozzles from the first row. The third and fourth groups include alternating nozzles from the second row.

The present general inventive concept may be embodied in a general-purpose computer (including all devices having an information processing function) by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet).

As described above, by a missing nozzle detection method and apparatus according to embodiments of the present general inventive concept, a missing nozzle is detected by printing and scanning nozzles that are grouped according to a predetermined criterion. Accordingly, since resolving power can be improved and a missing nozzle can be exactly detected using an existing scan sensor instead of a high performance scan sensor, a manufacturing cost can be reduced and printing quality can be improved.

As described above, when a printing resolution of a printing unit is higher than a scanning resolution of a scanning unit, the printing unit groups nozzles into a plurality of separate groups of nozzles of which a printing result can be scanned by the scanning unit.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to detect a missing nozzle among a plurality of nozzles, the apparatus comprising:
a nozzle classifying unit which groups nozzles by classifying the nozzles according to a predetermined criterion;
a print unit which prints each of the classified groups of nozzles; and
a nozzle inspection unit which detects a missing nozzle by scanning a result printed by the print unit,
wherein the nozzle classifying unit classifies the nozzles based on a scanning resolution of the nozzle inspection unit.

2. The apparatus of claim 1, wherein the nozzle classifying unit groups the nozzles by classifying the nozzles such that all the nozzles can be inspected based on the scanning resolution of the nozzle inspection unit.

3. The apparatus of claim 1, wherein the nozzle classifying unit comprises:
a pitch calculator which calculates a dot pitch based on the scanning resolution of the nozzle inspection unit; and
a nozzle grouping unit which groups the nozzles by classifying the nozzles according to the calculated dot pitch.

4. The apparatus of claim 1, wherein the print unit sequentially prints each of the classified groups of nozzles on a printing medium.

5. The apparatus of claims 4, wherein the print unit moves the printing medium by a predetermined distance after printing using each of the classified groups of nozzles.

6. An apparatus to detect a missing nozzle among a plurality of nozzles, the apparatus comprising:
a nozzle classifying unit which groups the nozzles by classifying the nozzles such that each group includes nozzles in a row of a nozzle arrangement;
a print unit which prints each of the classified groups of nozzles; and
a nozzle inspection unit which detects the missing nozzle by scanning the result printed by the print unit.

7. The apparatus of claim 6, wherein the nozzle classifying unit groups the nozzles by classifying the nozzles such that each group including the nozzles in the rows of a nozzle arrangement whose identification numbers have the same remainder when divided by a predetermined natural number.

8. The apparatus of claim 7, wherein the nozzle classifying unit varies the natural number according to the scanning resolution of the nozzle inspection unit.

9. The apparatus of claim 6, wherein the print unit sequentially prints using each of the classified groups of nozzles on a printing medium.

10. The apparatus of claim 9, wherein the print unit moves the printing medium by a predetermined distance after printing each of the classified groups of nozzles.

11. A method of detecting a missing nozzle among a plurality of nozzles, the method comprising:
grouping the nozzles by classifying the nozzles according to a predetermined criterion;
printing each of the classified groups of nozzles;
detecting the missing nozzle by scanning a result obtained by printing in the printing,
wherein in the grouping of the nozzles, the nozzles are classified based on a scanning resolution used in the detecting.

12. The method of claim 11, wherein in the grouping of the nozzles, the nozzles are grouped by classifying the nozzles such that all the nozzles can be inspected based on the scanning resolution in the detecting of the missing nozzle.

13. The method of claim 11, wherein the grouping of the nozzles comprises:
calculating a dot pitch based on the scanning resolution used in the detecting of the missing nozzle; and
grouping the nozzles by classifying the nozzles according to the calculated dot pitch.

14. The method of claim 11, wherein in the printing of each of the classified groups of nozzles, each of the classified groups of nozzles is sequentially printed on a printing medium.

15. The method of claims 14, wherein the printing of each of the classified groups of nozzles, comprises moving the printing medium by a predetermined distance after printing each of the classified groups of nozzles.

16. A method of detecting a missing nozzle among a plurality of nozzles, the method comprising:
grouping the nozzles by classifying the nozzles, each group including nozzles in the row of a nozzle arrangement;
printing each of the classified groups of nozzles; and
detecting the missing nozzle by scanning a result printed in the printing.

17. The method of claim 16, wherein in the grouping of the nozzles, the nozzles are grouped in the rows of a nozzle arrangement whose identification numbers have the same remainder when divided by a predetermined natural number.

18. The method of claim 17, wherein in the grouping of the nozzles, the natural number is varied according to a scanning resolution used in the detecting of the missing nozzle.

19. The method of claim 16, wherein in the printing of each of the classified groups of nozzles, each of the classified groups of nozzles is sequentially printed on a printing medium.

20. The method of claims 19, wherein the printing of each of the classified groups of nozzles comprises moving the printing medium by a predetermined distance after printing each of the classified groups of nozzles.
